(19) United States
(12) Patent Application Publication
(10) Pub. No.: US 2022/0307831 A1
(43) Pub. Date: Sep. 29, 2022

(54) INFORMATION PROCESSING DEVICE AND INFORMATION PROCESSING METHOD

(71) Applicant: TOPCON CORPORATION, Tokyo (JP)

(72) Inventor: Takeshi KIKUCHI, Tokyo (JP)

(21) Appl. No.: 17/678,530

(22) Filed: Feb. 23, 2022

(30) Foreign Application Priority Data
Mar. 29, 2021 (JP) 2021-054860

(51) Int. Cl. G01C 15/00; G06N 20/00; G01C 5/00; G06Q 30/06

(52) U.S. Cl. CPC G01C 15/00; G06N 20/00; G01C 5/00; G06Q 30/0631; G06Q 30/0627

(57) ABSTRACT

An object is to recognize an instrument mismatch with respect to a use situation of a user for a surveying instrument. An information processing device includes an input information creating unit configured to collect information stored in each surveying instrument from a plurality of surveying instruments, and create learning data by associating surveying instrument information, information on measuring function, and information on measuring amount; and a learning model generating unit configured to execute machine learning by using the learning data, and when information on object measuring function and information on object measuring amount used in an object surveying instrument owned or managed by the user are input, generate a learning model for estimating suitable surveying instruments with respect to the information on object measuring function and the information on object measuring amount.

### TECHNICAL FIELD

The present invention relates to an information processing device and an information processing method, and more specifically, to an information processing device and an information processing method for recognizing a user's instrument mismatch.

### BACKGROUND ART

As for surveying instruments, there are instrument types such as levels, theodolites, total stations, and 3D scanners, . . . etc. In general terms, a level is an instrument suitable for horizontal direction measuring and height difference measuring between object points, a theodolite is an instrument suitable for performing angle measuring of a horizontal angle and an elevation angle of an object point, a total station is an instrument suitable for measuring three-dimensional coordinates of a prism or an object point other than a prism by distance and angle measuring, and a scanner is an instrument suitable for measuring three-dimensional coordinates of a plurality of object points, and in recent years, there are sophisticated instruments including total stations with application functions such as a piling support function and an area calculating function, and a scanner with application functions such as a backward intersection support function (refer to, for example, Patent Literature 1 for the total station).

### CITATION LIST

### Patent Literature

Patent Literature 1: Japanese Published Unexamined Patent Application No. 2012-202821

### SUMMARY OF INVENTION

### Technical Problem

As described above, there are a large number of types of surveying instruments, and as surveying instruments of the same type, there are a large number of products with different specifications and functions. Therefore, in actuality, there are cases where, as compared with a purpose of use and use situation of a user, it is found that the user uses an excessively high-spec instrument, or conversely, uses a low-spec instrument, or a different instrument type is more suitable, etc. When such an instrument mismatch occurs, it is likely that a user has paid too much in user fees or performs inefficient work.

The present invention was made to solve the problem described above, and an object thereof is to recognize an instrument mismatch with respect to a use situation of a user for a surveying instrument.

### Solution to Problem

In order to solve the problem described above, an information processing device according to an aspect of the present invention includes an input information creating unit configured to collect information stored in each surveying instrument from a plurality of surveying instruments, and create learning data by associating surveying instrument information, information on measuring function used, and information on measuring amount used; and a learning model generating unit configured to execute machine learning by using the learning data, and when information on object measuring function and information on object measuring amount used in an object surveying instrument owned or managed by a user are input, generate a learning model for estimating a suitable surveying instrument with respect to the information on object measuring function and the information on object measuring amount.

In the aspect described above, it is also preferable that the input information creating unit extracts, as the information on measuring function, at least functions of distance measuring, angle measuring, prism distance measuring, horizontal direction measuring, height difference measuring, and various kinds of application surveys.

In the aspect described above, it is also preferable that the input information creating unit extracts, as the information on measuring amount, at least the number of measurements, the number of measurement points, a measuring range, and an operating time.

In the aspect described above, it is also preferable that the input information creating unit extracts, as the surveying instrument information, at least a model number type of each of the surveying instruments.

In addition, in order to solve the problem described above, an information processing device according to an aspect of the present invention includes an object information acquiring unit configured to acquire information stored in an object surveying instrument owned or managed by a user as object data; an object information extracting unit configured to extract information on object measuring function and information on object measuring amount used in the object surveying instrument from the object data; an estimating unit configured to execute machine learning by using surveying instrument information, information on measuring function, and information on measuring amount as learning data from collected data collected by information stored in each surveying instrument from a plurality of surveying instruments, and when the information on object measuring function and the information on object measuring amount are input, estimate a suitable surveying instrument for an actual use situation of the user by inputting the information on object measuring function and the information on object measuring amount into a learning model for estimating a suitable surveying instrument with respect to the information on object measuring function and the information on object measuring amount; and a result providing unit configured to provide estimation results by the estimation unit to the user.

In the aspect described above, it is also preferable that the object information acquiring unit acquires the object data in a set totaling period, the estimating unit performs estimation at intervals of the totaling period, and the result providing unit provides the estimation results to the user at intervals of the totaling period.

In the aspect described above, it is also preferable that the result providing unit displays surveying instruments based on the estimation results in descending order of score on a terminal device of the user, and proposes a replacement purchase or an additional purchase of a surveying instrument.

In the aspect described above, it is also preferable that, for each customer of the user, the result providing unit displays surveying instruments based on the estimation results in descending order of score on a terminal device of the user, and proposes a replacement purchase or an additional purchase of a surveying instrument.

In addition, in order to solve the problem described above, an information processing method according to an aspect of the present invention is an information processing method to be executed by a computer, and includes a step of collecting information stored in each surveying instrument as collected data from a plurality of surveying instruments; a step of extracting surveying instrument information, information on measuring function, and information on measuring amount, from the collected data, and creating a set of the surveying instrument information, the information on measuring function, and the information on measuring amount as learning data; a step of executing machine learning by using the learning data, and when information on object measuring function and information on object measuring amount used in an object surveying instrument owned or managed by a user are input, generating a learning model for estimating a suitable surveying instrument with respect to the information on object measuring function and the information on object measuring amount; a step of acquiring information stored in the object surveying instrument as object data; a step of estimating a suitable surveying instrument for an actual use situation of the user by inputting the information on object measuring function and the information on object measuring amount into the learning model; and a step of providing estimation results to the user.

### Advantageous Effects of Invention

According to the present invention, a technique to recognize an instrument mismatch with respect to a use situation of a user for a surveying instrument can be provided.

### BRIEF DESCRIPTION OF DRAWINGS

FIG. 1 is a diagram describing a learning model for information processing according to the present embodiment.

FIG. 2 is a view describing a schematic configuration for information processing according to the present embodiment.

FIG. 3 is a diagram illustrating a configuration example of an information processing device according to the present embodiment.

FIG. 4 illustrates an example of collected data from a certain surveying instrument.

FIG. 5 is a flowchart of a learning phase of information processing according to the present embodiment.

FIG. 6 is a diagram illustrating a configuration example of a terminal device according to the present embodiment.

FIG. 7 illustrates an example of estimation results through information processing according to the present embodiment.

FIG. 8 illustrates an example of estimation results through information processing according to the present embodiment.

FIG. 9 is a flowchart of an estimation phase of information processing according to the present embodiment.

### DESCRIPTION OF EMBODIMENTS

Next, a preferred embodiment of the present invention will be described with reference to the drawings.

1. Outline of Information Processing

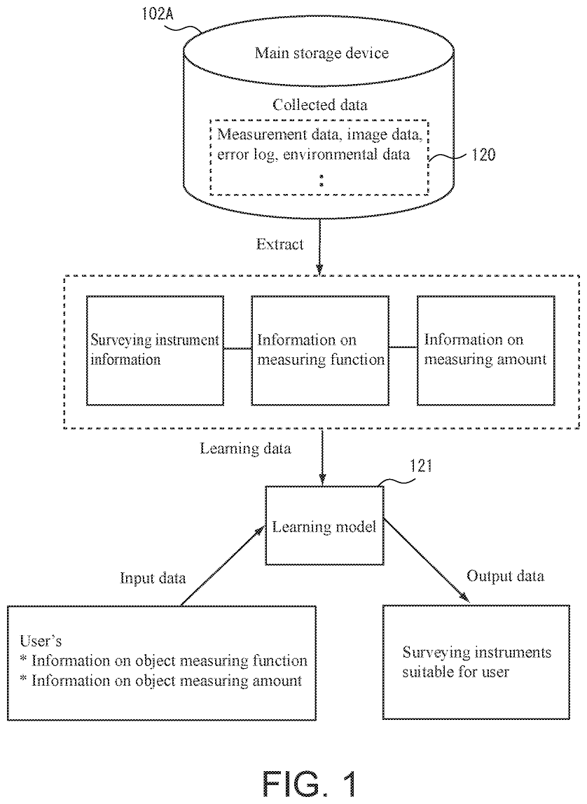

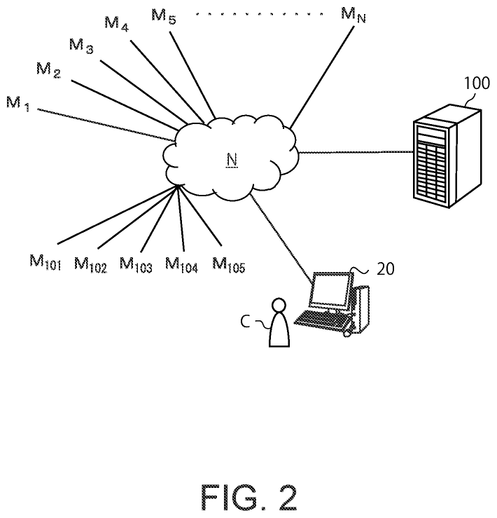

First, an outline of information processing according to the present embodiment will be described. FIG. 1 is a diagram describing a learning model for information processing according to the present embodiment, and FIG. 2 is a diagram describing a schematic configuration for the same information processing.

An information processing device 100 illustrated in FIG. 2 is a management server owned by a surveying instrument manufacturer. The information processing device 100 is connected to a plurality of surveying instruments M₁, M₂, . . . M_{N} provided by the surveying instrument manufacturer through a communication network N. The communication network N is, for example, a WAN (Wide Area Network) such as the Internet. The surveying instruments are, for example, levels, theodolites, transits, total stations, GNSS devices, laser markers, laser distance meters, and 3D scanners, etc. The surveying instruments M₁, M₂, . . . M_{N} transmit data stored in the respective surveying instruments to the information processing device 100 at timings such as at regular time intervals (hourly, daily, weekly, monthly, etc.), or for each measurement or each time the power supply is turned on.

The information processing device 100 collects data from the surveying instruments M₁, M₂, . . . M_{N} through the communication network N. As illustrated in FIG. 1, the information processing device 100 extracts, from the big data (hereinafter, referred to as “collected data 120”) collected from the surveying instruments M₁, M₂, . . . M_{N}, “surveying instrument information,” “information on measuring function” used, and “information on measuring amount” used. The information processing device 100 executes machine learning by using the sets of these information as “learning data” and generate a learning model 121.

As illustrated in FIG. 2, the information processing device 100 is connected to a terminal device 20 through the communication network N. The terminal device 20 is connected to surveying instruments M₁₀₁ to M₁₀₅ through the communication network N. The terminal device 20 is a desk-top PC (Personal Computer), etc., owned by a user C, and the user C is an owner of the surveying instruments or a user who rents the surveying instruments, or an agent (dealer) of the surveying instruments. The surveying instruments M₁₀₁ to M₁₀₅ are surveying instruments owned or managed by the user C (hereinafter, referred to as “object surveying instruments”). From the terminal device 20, a webpage for managing the surveying instruments M₁₀₁ to M₁₀₅ can be opened. Such a communication management system for surveying instruments can be configured as publicly known as disclosed in, for example, Japanese Published Unexamined Patent Application No. 2019-7903, etc. The user can receive estimation results of the learning model 121 through the webpage.

As illustrated in FIG. 1, the information processing device 100 extracts information on measuring function and information on measuring amount of the object surveying instruments M₁₀₁ to M₁₀₅ of the user C as “input data,” and inputs these as “information on object measuring function” and “information on object measuring amount” into the learning model 121. It can be said that the information on object measuring function and the information on object measuring amount are an actual use situation of the user C. In response to the input of the “information on object measuring function” and “information on object measuring amount,” the learning model 121 outputs “suitable surveying instruments” for the user C.

Then, according to the output data (estimation results), the information processing device 100 proposes an additional purchase or replacement purchase of a surveying instrument to the user C. These are the outline of information processing to be performed in the present embodiment. Hereinafter, the information processing will be described in detail in a divided manner into a learning phase and an estimation phase.

2. Information Processing in Learning Phase

2-1. Configuration of Information Processing Device

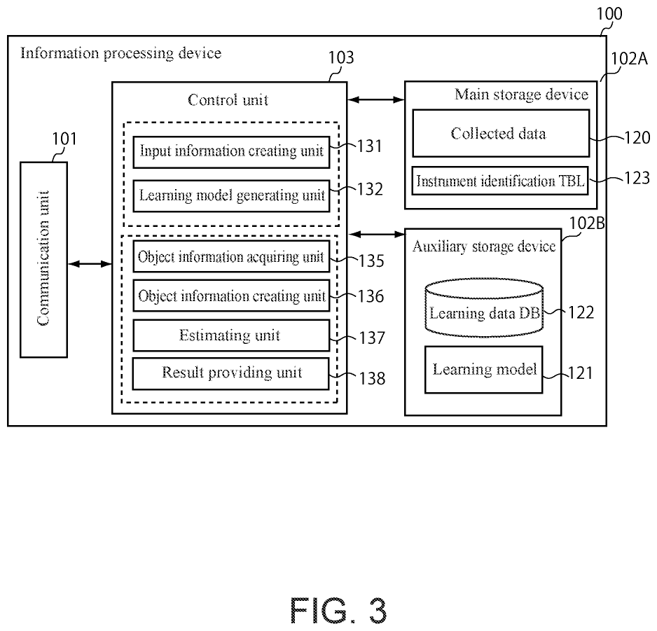

A detailed configuration of the information processing device 100 in a learning phase will be described. FIG. 3 is a diagram illustrating a configuration example of the information processing device 100. The information processing device 100 is a so-called server computer. The information processing device 100 includes a communication unit 101, a main storage device 102A, an auxiliary storage device 102B, and a control unit 103.

The communication unit 101 is a communication control device such as a network adapter, a network interface card, or a LAN card, and connects the information processing device 100 to the communication network N by wire or wirelessly. The control unit 103 transmits and receives various information to and from the surveying instruments M₁, M₂, . . . M_{N} (FIG. 2) through the communication unit 101 and the communication network N.

The main storage device 102A is a semiconductor memory device such as a RAM (Random Access Memory) or a flash memory, or a storage medium such as an HDD (Hard Disc Drive) or an optical disc.

In the main storage device 102A, “collected data 120” collected from the plurality of surveying instruments M₁, M₂, . . . M_{N} is stored. The collected data 120 includes various data such as, in addition to the “surveying instrument information,” “information on measuring function,” and “information on measuring amount” described later, measurement data, image data, audio data, environmental data, error logs, machine logs of components, and data on a maintenance period and a rental period. Each time new data is accepted, the main storage device 102A associates collected data with an identification ID provided for an individual number of each surveying instrument so that the data can be identified by measurement or date. The collected data is also used for the purpose of measurement data analysis and error analysis, etc., other than in the present embodiment. The collected data 120 may be stored not in the main storage device 102A but in a server or a cloud storage different from the information processing device 100.

For extraction of the “surveying instrument information” described later, the main storage device 102A stores an instrument identification table 123 for identifying an “instrument type” of a surveying instrument such as a level/a theodolite/a total station/a scanner, etc., and a “model number type (model number)” of surveying instruments of the same type based on individual numbers of the surveying instruments. The instrument identification table 123 may also be stored not in the main storage device 102A but in a server or a cloud storage different from the information processing device 100.

The auxiliary storage device 102B is a storage medium such as an SRAM, a flash memory, or an HDD. In the auxiliary storage device 102B, the learning model 121 and a learning data DB 122 are stored. These may also be stored not in the auxiliary storage device 102B but in a server or a cloud storage different from the information processing device 100.

The learning data DB 122 stores a plurality of learning dataset created by an input information creating unit 131 described later. The learning model 121 is generated by a learning model generating unit 132 described later, and functions as a classifier made as a result of machine learning. This will be described in detail in the description of the learning model generating unit 132.

The control unit 103 consists of one or a plurality of CPUs (Central Processing Units), multicore CPUs, or GPUs (Graphics Processing Units), etc. The control unit 103 is connected to respective hardware units constituting the information processing device 100 through a bus.

The control unit 103 includes, as functional units, the input information creating unit 131, the learning model generating unit 132, an object information acquiring unit 135, an object information extracting unit 136, an estimating unit 137, and a result providing unit 138. Among these, the input information creating unit 131 and the learning model generating unit 132 function in a learning phase. The remaining functional units 135, 136, 137, and 138 function in an estimation phase.

Functions of the respective units are realized by, for example, reading and executing programs stored in the ROM or the main storage device 102A by the CPU. Part of the respective units may consist of hardware such as ASIC (Application Specific Integrated Circuit) or FPGA (Field-Programmable Gate Array).

The input information creating unit 131 extracts “surveying instrument information,” “information on measuring function,” and “information on measuring amount” from the collected data 120 collected in the main storage device 102A with respect to each surveying instrument.

The input information creating unit 131 extracts an “instrument type” and a “model number type” of each surveying instrument as “surveying instrument information.” When the “instrument type” and “model number type” are not included in the collected data 120, based on an individual number of the surveying instrument, at least the “model number type” is extracted by referring to the instrument identification table 123.

The input information creating unit 131 extracts, as “information on measuring function,” a function used among at least a distance-measuring function, an angle-measuring function, a prism distance-measuring function, a horizontal direction measuring function, a height difference measuring function, and application functions. More specifically, as for application functions, for example, in the case of a total station, a function used is extracted among radiation observation, coordinate observation, pair of observations, piling support, opposite side measurement, traverse calculation, area calculation, and topographical survey, etc.

The input information creating unit 131 extracts, as “information on measuring amount,” amounts used among at least the number of measurements, the number of measurement points, a measurement range, and an operating time, in the form of “numerical values.”

The input information creating unit 131 associates the sets of these “surveying instrument information,” “information on measuring function,” and “information on measuring amount” with an identification ID of each surveying instrument, and stores these as “learning data” in the learning data DB 122. The input information creating unit 131 performs this creating work for the collected data 120 at predetermined timings, that is, each time new data is accepted, or at regular time intervals (hourly, every several hours, daily, etc.).

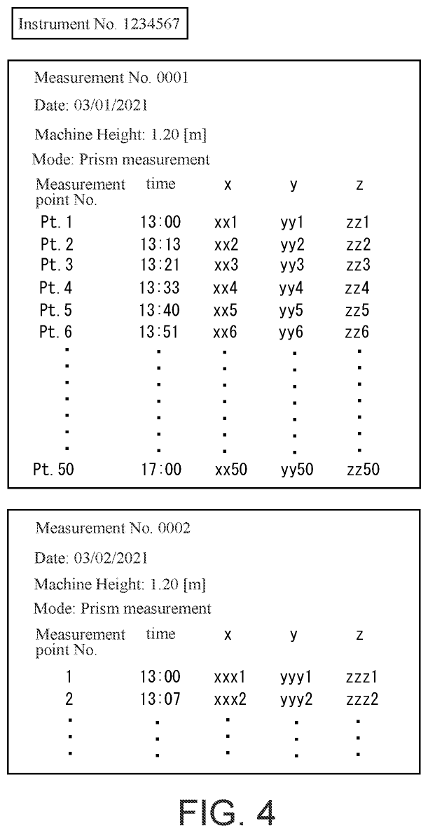

A detailed example of the learning data creation by the input information creating unit 131 is described. FIG. 4 is assumed to be part of collected data from a certain total station (identification ID: TS7210). In “Measurement No. 0001” of this total station (identification ID: TS7210), with an instrument with an individual No. 1234567, a measurement is performed from 13:00 to 17:00 on Mar. 1, 2021, and three-dimensional coordinates of object points Pt1 to Pt5 are measured by prism measurement. The input information creating unit 131 extracts that the surveying instrument (identification ID: TS7210) in this measurement is of an instrument type of “total station” and a model number type of “TS-600,” and “Prism distance measuring (angle measuring)” was used as a measuring function, and the measuring amount is “the number of measurements (score): 50 points” and “operating time: 4 hours,” and creates a set of “total station,” “model number TS-600,” “prism distance measuring (angle measuring),” “the number of measurements (score): 50” and “operated for 4 hours,” and stores this set in the learning data DB 122.

The learning model generating unit 132 reads learning data from the learning data DB 122 and executes machine learning to generate the learning model 121. The learning model 121 is realized by a neural network using one or a plurality of layers of nonlinear units for predicting an output responding to an input. The learning model 121 generated by the learning model generating unit 132 is stored in the auxiliary storage device 102B.

As an example, the learning model generating unit 132 uses teacherless learning such as clustering or a known statistical procedure so that samples are grouped by “model number type” of the surveying instruments, and generates the learning model 121 for grasping, as characteristics of the respective samples included in a certain surveying instrument (group of a certain model number type), a “general use model” including a measuring function generally used in this surveying instrument and a measuring amount of the measuring function. The “general use model” is created to have content in which, for example, in a total station (model No. C-1000), 100 prism measurements and 100 non-prism measurements are performed on monthly average.

When input data of the user C is input into this learning model 121, by comparison with the “general use model” of each surveying instrument (group of a certain model number type), based on similarity or statistical numerical values such as averages, medians, modes, accumulated values, and standard deviation, or based on shape matching with a shape obtained by defining the general use model as a graphic, or based on a combination of these, one or some surveying instruments having use patterns similar to the input data of the user C are output.

The learning model generating unit 132 may perform the above-described processing for each “instrument type” of surveying instruments. However, the above-described processing is just an example of the learning model generating unit 132, and the learning model generating unit 132 may generate the learning model 121 by using other methods of teacherless machine learning such as a principal component analysis.

The object information acquiring unit 135, the object information extracting unit 136, the estimating unit 137, and the result providing unit 138 will be described in an estimation phase.

2-2. Information Processing Method in Learning Phase

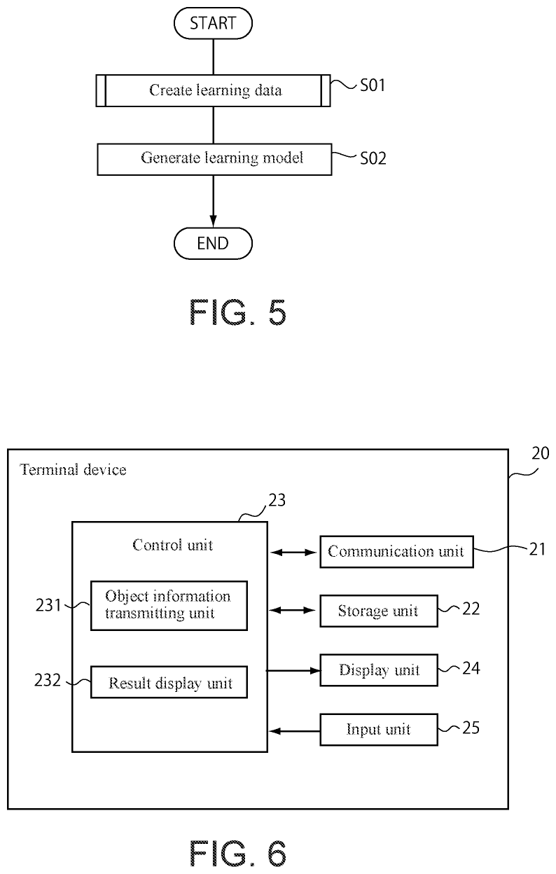

FIG. 5 is a flowchart of a learning phase by the information processing device 100 according to the present embodiment. When the processing is started, in Step SOL the input information creating unit 131 extracts “surveying instrument information,” “information on measuring function,” and “information on measuring amount” from collected data 120 collected in the main storage device 102A, and creates learning data.

Next, in Step S02, the learning model generating unit 132 executes machine learning to generate a learning model 121. After the learning model 121 is stored in the auxiliary storage device 102B, the processing is ended.

3. Information Processing in Estimation Phase

3-1. Configuration of Terminal Device

First, the terminal device 20 (FIG. 2) to be used in an estimation phase will be described. The terminal device 20 is a desktop PC, a notebook PC, a tablet terminal, a mobile phone, a PDA (Personal Digital Assistant), etc., owned by the user C. The terminal device 20 is connected to object surveying instruments M₁₀₁ to M₁₀₅ used or managed by the user C. From the object surveying instruments M₁₀₁ to M₁₀₅, data stored in the respective object surveying instruments M₁₀₁ to M₁₀₅ are transmitted to the terminal device 20 or a management server, etc., (not illustrated) used by the user C through the communication network N at timings such as at regular time intervals, for each measurement, or each time the power supply is turned on.

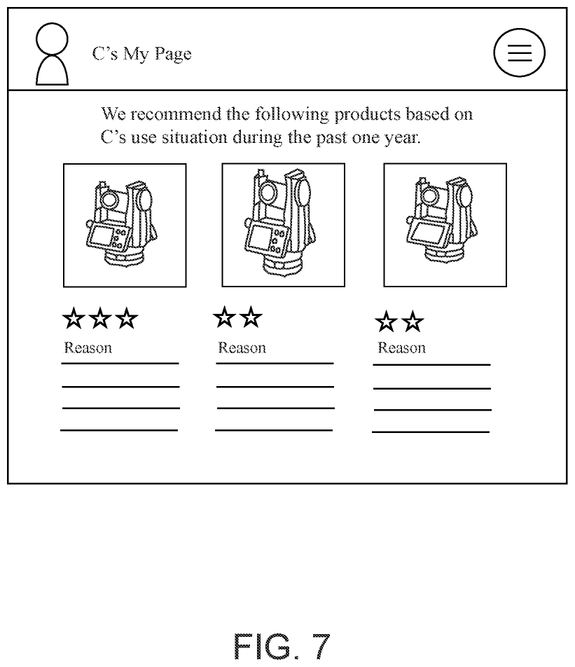

FIG. 6 is a diagram illustrating a configuration example of the terminal device 20. The terminal device 20 includes a communication unit 21, a storage unit 22, a control unit 23, a display unit 24, and an input unit 25.

The communication unit 21 is a communication control device such as a network adapter, a network interface card, or a LAN card. The communication unit 21 connects the terminal device 20 to the communication network N by wire or wirelessly. The control unit 23 can transmit and receive various information to and from the information processing device 100 through the communication unit 21 and the communication network N.

The display unit 24 is an organic EL display or a liquid crystal display. The display unit 24 displays various information on a webpage based on control of the control unit 23.

The input unit 25 is a keyboard including character keys, numeric keys, and an enter key, etc., a mouse, a power supply button, etc. The user C can operate the webpage through the input unit 25. The display unit 24 and the input unit 25 may be configured integrally as a touch panel display.

The storage unit 22 is, for example, a semiconductor memory device such as a RAM or a flash memory, or a storage medium such as an HDD or an optical disc. The storage unit 22 stores software of applications to be executed by the terminal device 20. The storage unit 22 may store information received from the object surveying instruments M₁₀₁ to M₁₀₅.

The control unit 23 includes a microcomputer including a CPU, a ROM, a RAM, and I/O ports, etc., and various circuits. The control unit 23 reads and executes various programs stored in the storage unit 22 and the RAM. The control unit 23 includes an object information transmitting unit 231 and a result display unit 232. The functions of the respective functional units are realized by, for example, reading and executing programs stored in the ROM or the storage unit 22.

The object information transmitting unit 231 acquires information on the object surveying instruments M₁₀₁ to M₁₀₅ of the user C from the storage unit 22 or a management server, etc., of the user C and transmits the information to the information processing device 100 on a request from the object information acquiring unit 135 of the information processing device 100. It is also possible that the user C selects an object surveying instrument, information on which is to be transmitted to the information processing device 100, through the webpage.

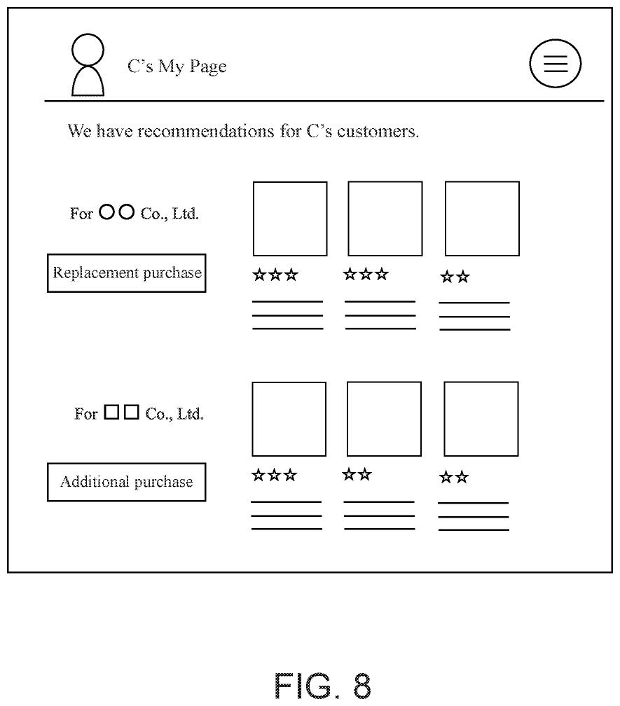

The result display unit 232 receives estimation results from the result providing unit 138 described later, and displays the estimation results on the display unit 24. The estimation results are displayed in response to push notification or on a request from the user C. The estimation results that the result display unit 232 receives from the result providing unit 138 will be described in detail later with reference to FIGS. 7 and 8.

3-2. Configuration of Information Processing Device

The configuration of the information processing device 100 has already been illustrated in FIG. 3. The object information acquiring unit 135, the object information extracting unit 136, the estimating unit 137, and the result providing unit 138 which function in the estimation phase will be described.

The object information acquiring unit 135 acquires information stored in the object surveying instruments M₁₀₁ to M₁₀₅ of the user C as “object data.” The “object data” includes, as with the collected data 120, in addition to information on measuring function and information on measuring amount of the object surveying instruments, various information such as measurement data, image data, audio data, error code data, operating time data of components, driving data of components, and data on maintenance periods and rental periods.

Here, it is preferable that the object information acquiring unit 135 acquires the “object data” at intervals of a set “totaling period (unit period).” The totaling period can be set by minutes, hours, days, weeks, months, quarters, seasons, years, decade by decade, etc., or designated as a period such as “from Jan. 5, 2021 to Feb. 20, 2021.” As the totaling period, a default value is determined in the information processing device 100, however, it is preferable that the totaling period can be changed by the user C through the webpage.

The object information extracting unit 136 extracts information on measuring function and information on measuring amount used in the object surveying instruments M₁₀₁ to M₁₀₅ as “information on object measuring function” and “information on object measuring amount” from the “object data” acquired by the object information acquiring unit 135 in the same manner as in the input information creating unit 131, and uses these as input data of the user C. The object information extracting unit 136 functions each time the object information acquiring unit 135 acquires object data.

The estimating unit 137 inputs the input data of the user C into the learning model 121, and estimates “suitable surveying instruments” with respect to the “information on object measuring function” and “information on object measuring amount” of the user C (that is, an actual use situation of the user C). The estimating unit 137 functions each time the object information extracting unit 136 performs the extraction. That is, the estimating unit 137 performs one estimation at intervals of the “totaling period.”

“Estimation examples” of the estimating unit 137 are as follows.

### ESTIMATION EXAMPLES

(i) From the “information on object measuring function” and the “information on object measuring amount,” when it is found that a utilization rate of angle measuring with respect to a single point by the user C is high, the estimating unit 137 is likely to estimate any one of model number types of “theodolites.”
(ii) From the “information on object measuring function” and the “information on object measuring amount,” when it is found that a utilization rate of horizontal direction measuring and height difference measuring by the user C is high, the estimating unit 137 is likely to estimate any one of model number types of “levels.”
(iii) From the “information on object measuring function” and the “information on object measuring amount,” when it is found that the number of measurement points is large or the measurement range is wide at one site of the user C, the estimating unit 137 is likely to estimate any one of model number types of “scanners.”
(iv) From the “information on object measuring function” and the “information on object measuring amount,” when it is found that the number of prism measurements is large at one site of the user C, the estimating unit 137 is likely to estimate any one of model number types of “total stations” resistant to motor driving.
(v) From the “information on object measuring function” and the “information on object measuring amount,” when it is found that the user C performs distance and angle measuring but rarely uses the application functions, the estimating unit 137 is likely to estimate any one of model number types of inexpensive “total stations” equipped with no application functions.

Based on the learning model 121, the estimating unit 137 estimates one or several types of surveying instruments close to the input data of the user C (the “information on object measuring function” and the “information on object measuring amount”). The estimating unit 137 scores surveying instruments whose “general use model” patterns based on the learning model 121 are close to the input data according to numerical values of, for example, similarities, averages, medians, modes, accumulated values, and standard deviation, etc., or numerical values of matching ratios, etc., of shape matching with the “general use model,” or a combination of these, and determines surveying instruments with high scores as estimation results.

The result providing unit 138 presents the surveying instruments estimated by the estimating unit 137 on the result display unit 232 of the terminal device 20 in descending order of score together with reasons for recommendation. The reason for recommendation includes content proposing a replacement purchase or additional purchase of the surveying instrument.

For example, when the user C uses a sophisticated total station with a large number of application functions, the result providing unit 138 respectively proposes additional purchases of a theodolite, a level, and a scanner in cases where the estimating unit 137 presents the estimation examples (i) to (iii). When the estimating unit 137 presents the estimation examples (iv) to (v), the result providing unit 138 proposes a replacement purchase of a total station of a different model number (specifications).

With reference to FIGS. 7 and 8, an example of content of a proposal by the result providing unit 138 from the estimation results of the estimating unit 137 will be described. FIG. 7 is a display example for the user C (user) who owns or rents the object surveying instruments M₁₀₁ to M₁₀₅. To the user C, one or a plurality of surveying instruments are recommended in descending order of score. On the webpage of the user C, the estimated surveying instruments are displayed together with star marks, etc., expressing scores and reasons for recommendation. For example, when the estimating unit 137 presents the “estimation example” (i), comments such as “From C's use situation during the past one year, the utilization rate of angle measuring with respect to a single point is high, and the use time was 120 hours and 43 minutes. Theodolites are suitable for measurements of a horizontal angle and an elevation angle of a single point, and the theodolite (model number B-100) has battery duration of 150 hours. We recommend a purchase of the theodolite (model number B-100).” are described. For example, when the estimating unit 137 presents the “estimation example” (v), comments such as “From C's use situation during the past one year, the use of the application survey functions by C is only 3% of the total use. The total station (model number C-1000) has specifications set so that the application functions are opened by charging only when a user wants to use them, and is a model we offer at a lower price corresponding to the specifications. We recommend a replacement purchase of the total station (model number C-1000).” are described. FIG. 8 illustrates a display example for the user C (dealer) who sells or rents the object surveying instruments M₁₀₁ to M₁₀₅. To the user C, content as illustrated in FIG. 7 is provided for each customer of the dealer. As illustrated in FIG. 8, it is also preferable that a “replacement purchase” and an “additional purchase” are displayed as icons so that a user can know the proposal without reading a reason for recommendation. FIGS. 7 and 8 are proposal examples, and the proposal is not limited to these.

3-3. Information Processing Method in Estimation Phase

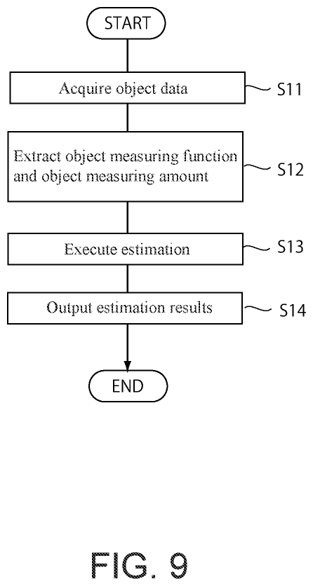

FIG. 9 is a flowchart of an estimation phase of the information processing device 100 according to the present embodiment. When the processing is started, in Step S11, the object information acquiring unit 135 acquires “object data” of the object surveying instruments M₁₀₁ to M₁₀₅ of the user C from the terminal device 20. The object information acquiring unit 135 acquires all past object data when accessing the information of the object surveying instruments M₁₀₁ to M₁₀₅ for the first time, and acquires object data after the previous totaling period when the totaling period is determined.

Next, in Step S12, the object information extracting unit 136 extracts “information on object measuring function” and “information on object measuring amount” from the “object data.”

Next, in Step S13, the estimating unit 137 inputs the “information on object measuring function” and the “information on object measuring amount” extracted in Step S12 into the learning model 121, and estimates surveying instruments suitable for an actual use situation of the user C.

Next, in Step S14, the estimation results are output by the result providing unit 138 to the terminal device 20 of the user C, and the processing is ended.

4. Effect

As described above, according to the present embodiment, the information processing device 100 is configured to extract “surveying instrument information,” “information on measuring function,” and “information on measuring amount” from big data of the surveying instruments, and by inputting an actual use situation (“information on object measuring function” and “information on object measuring amount”) of a user into the learning model 121 obtained by machine learning by using the sets of these “surveying instrument information,” “information on measuring function,” and “information on measuring amount” as learning data, estimate surveying instruments suitable for the actual use situation of the user. Accordingly, by comparison with the actual use situation, the user can know use of an excessively high-spec instrument or, conversely, use of a low-spec instrument, or can know the fact that a different instrument type is more suitable, etc. That is, according to the present embodiment, the user can recognize such an instrument mismatch, and can consider a replacement purchase of an inexpensive model or a change in contract plan according to estimation results. When the user is a dealer, the dealer can obtain materials for a proposal of a replacement purchase or an additional purchase to a customer.

According to the present embodiment, the information processing device 100 is configured to perform one estimation at intervals of a “totaling period,” and configured so that the “totaling period” can be arbitrarily changed by the user C. Accordingly, the user C can recognize an instrument mismatch according to the user's or customer's needs weekly, monthly, quarterly, or seasonally. Therefore, the user can more specifically consider a purchase or rental, and this leads to an improvement in customer satisfaction.

The present embodiment is configured so that the learning phase and the estimation phase are realized by the same information processing device 100, however, the learning phase and the estimation phase may be realized by different information processing devices. In this case, the information processing device that executes the estimation phase is configured to store the learning model 121 in the storage unit, or made accessible to a storage medium storing the learning model 121.

The preferred embodiment and modifications of the present invention have been described above, and the embodiment and modifications described above are examples of the present invention, and the embodiment and modifications can be combined based on the knowledge of a person skilled in the art, and such a combined embodiment is also included in the scope of the present invention.

### REFERENCE SIGNS LIST

100 Information processing device
121 Learning model
122 Learning data DB
103 Control unit
131 Input information creating unit
132 Learning model generating unit
135 Object information acquiring unit
136 Object information extracting unit
137 Estimating unit
138 Result providing unit
20 Terminal device
23 Control unit
231 Object information transmitting unit
232 Result display unit
24 Display unit

1. An information processing device comprising:
an input information creating unit configured to collect information stored in each surveying instrument from a plurality of surveying instruments, and create learning data by associating surveying instrument information, information on measuring function used, and information on measuring amount used; and
a learning model generating unit configured to execute machine learning by using the learning data, and when information on object measuring function and information on object measuring amount used in an object surveying instrument owned or managed by a user are input, generate a learning model for estimating a suitable surveying instrument with respect to the information on object measuring function and the information on object measuring amount.

2. The information processing device according to claim 1, wherein
the input information creating unit extracts, as the information on measuring function, at least functions of distance measuring, angle measuring, prism distance measuring, horizontal direction measuring, height difference measuring, and various kinds of application surveys.

3. The information processing device according to claim 1, wherein
the input information creating unit extracts, as the information on measuring amount, at least the number of measurements, the number of measurement points, a measuring range, and an operating time.

4. The information processing device according to claim 1, wherein
the input information creating unit extracts, as the surveying instrument information, at least a model number type of each of the surveying instruments.

5. An information processing device comprising:
an object information acquiring unit configured to acquire information stored in an object surveying instrument owned or managed by a user as object data;
an object information extracting unit configured to extract information on object measuring function and information on object measuring amount used in the object surveying instrument from the object data;
an estimating unit configured to execute machine learning by using surveying instrument information, information on measuring function, and information on measuring amount as learning data from collected data collected by information stored in each surveying instrument from a plurality of surveying instruments, and when the information on object measuring function and the information on object measuring amount are input, estimate a suitable surveying instrument for an actual use situation of the user by inputting the information on object measuring function and the information on object measuring amount into a learning model for estimating a suitable surveying instrument with respect to the information on object measuring function and the information on object measuring amount; and
a result providing unit configured to provide estimation results by the estimation unit to the user.

6. The information processing device according to claim 5, wherein
the object information acquiring unit acquires the object data in a set totaling period,
the estimating unit performs estimation at intervals of the totaling period, and
the result providing unit provides the estimation results to the user at intervals of the totaling period.

7. The information processing device according to claim 5, wherein
the result providing unit displays surveying instruments based on the estimation results in descending order of score on a terminal device of the user, and proposes a replacement purchase or an additional purchase of a surveying instrument.

8. The information processing device according to claim 5, wherein
for each customer of the user, the result providing unit displays surveying instruments based on the estimation results in descending order of score on a terminal device of the user, and proposes a replacement purchase or an additional purchase of a surveying instrument.

9. An information processing method to be executed by a computer, comprising:
a step of collecting information stored in each surveying instrument as collected data from a plurality of surveying instruments;
a step of extracting surveying instrument information, information on measuring function, and information on measuring amount from the collected data, and creating a set of the surveying instrument information, the information on measuring function, and the information on measuring amount as learning data;
a step of executing machine learning by using the learning data, and when information on object measuring function and information on object measuring amount used in an object surveying instrument owned or managed by a user are input, generating a learning model for estimating a suitable surveying instrument with respect to the information on object measuring function and the information on object measuring amount;
a step of acquiring information stored in the object surveying instrument as object data;
a step of estimating a suitable surveying instrument for an actual use situation of the user by inputting the information on object measuring function and the information on object measuring amount into the learning model; and
a step of providing estimation results to the user.
